(19) United States
(12) Patent Application Publication
(10) Pub. No.: US 2019/0017229 A1
(43) Pub. Date: Jan. 17, 2019

(54) METHOD AND SYSTEM FOR STRENGTHENING AND HARDENING UNPAVED SURFACES

(71) Applicant: Investment Bikers, LLC d/b/a Petraviam, Austin, TX (US)

(72) Inventors: Chris Butler, Austin, TX (US); Dave Abboud, Cedar Park, TX (US); Mark Scott, Volente, TX (US); Mark Miller, Leander, TX (US)

(73) Assignee: Investment Bikers, LLC d/b/a Petraviam, Austin, TX (US)

(21) Appl. No.: 16/037,755

(22) Filed: Jul. 17, 2018

Related U.S. Application Data
(60) Provisional application No. 62/533,309, filed on Jul. 17, 2017.

(51) Int. Cl. E01C 7/36; C04B 26/00; E01C 21/00; E01C 15/00; E01C 19/46

(52) U.S. Cl. CPC E01C 7/36; C04B 26/00; E01C 19/46; E01C 15/00; E01C 21/00

(57) ABSTRACT

A method and system for strengthening and hardening unpaved surfaces is presented wherein a triglyceride composition is applied to an unpaved area. The composition is comprised of a homogenized mixture of one or more triglycerides, water, one or more surfactants, and, optionally, a catalyst. The triglycerides used in the composition are generally commercially-available oils and greases, such as naturally-derived oils that contain mono- and poly-unsaturated fatty acid triglycerides, such as those found in used cooking oil. The surfactant acts as a stabilizing agent and also aids in the saturation of the unpaved surface during application. The catalyst facilitates the drying and hardening process. The unpaved surface is compacted with a heavy roller and/or a vibratory compactor and then coated with an application of the triglyceride composition. In alternate embodiments, the triglyceride mixture is applied before the unpaved surface is compacted.

### PRIORITY STATEMENT UNDER 35 U.S.C. § 119 & 37 C.F.R. § 1.78

This non-provisional application claims priority based upon prior U.S. Provisional Patent Application Ser. No. 62/533,309 filed Jul. 17, 2017, in the names of Chris Butler, Dave Abboud, Mark Scott, and Mark Miller entitled “METHOD OF IMPROVING UNPAVED SURFACES FOR ROADS, PARKING AREAS, AND PATHS”, the disclosures of which are incorporated herein in their entirety by reference as if fully set forth herein.

### BACKGROUND OF THE INVENTION

Unpaved surfaces, while commonly used for parking lots, roads, and bike and walking paths, have several drawbacks. The surfaces are subject to damage from water erosion and vehicular traffic, and they may generate unacceptable levels of dust. Conventional paving or surface coating technologies have long been available to manage these problems, but they have a relatively high cost and may contain potentially toxic materials. The present invention describes a novel method for stabilizing and hardening unpaved surfaces using a low-cost, environmentally friendly composition to improve the surface and strength characteristics of the surface. The result is a low-dusting surface that is resistant to vehicular damage and water erosion.

### SUMMARY OF THE INVENTION

The system and process of the present invention involve the application of a triglyceride composition to an unpaved area to strengthen and harden the unpaved area. The triglyceride composition is comprised of a homogenized mixture of one or more triglycerides, water, one or more surfactants, and, optionally, one or more catalysts. The triglycerides used in the composition are generally commercially-available oils and greases, such as naturally-derived oils that contain mono- and poly-unsaturated fatty acid triglycerides. The surfactant acts as a stabilizing agent and also aids in the saturation of the unpaved surface during application.

In general terms, the surface of the unpaved area is initially graded, leveled, and filled where needed with road base and road base “fines.” Also, it may be necessary or desirable to remove vegetation, such as grass, weeds and the like, prior to, or as part of, this preparatory work. In some embodiments, a light application of the triglyceride composition is applied to the surface at this stage. Once the unpaved area has been prepared, the surface is then compacted with a heavy roller, a vibratory compactor, or both, and then coated with a final application of the triglyceride composition. In some instances, very little surface preparation will be required, such as areas that already have a compact layer of limestone road base or similar material at the surface. In other instances, multiple rounds of compaction and application of the composition of the present invention may be required to achieve the desired surface hardness.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### DESCRIPTION OF THE DRAWINGS

For a more complete understanding of the present invention, and the advantages thereof, reference is now made to the following descriptions taken in conjunction with the accompanying drawings, in which:

FIG. 1 shows the molecular structure of an unsaturated triglyceride molecule;

FIG. 2 shows the change to the molecular structure resulting from the reaction of air with an unsaturated triglyceride molecule to form a hydroperoxide;

FIG. 3 shows the change to the molecular structure resulting from the reaction of a hydroperoxide with an unsaturated triglyceride molecule to form a crosslink between the two triglyceride molecules;

FIG. 4 is a table showing the test results of a surface before and after the application of one embodiment of the composition of the present invention;

FIG. 5 is a table showing the affect of changing the ratio of triglycerides in the triglyceride composition of the present invention;

FIG. 6 is a table showing the affect of changing the amount of surfactant in the triglyceride composition of the present invention;

FIG. 7 is a table showing the affect of adding a catalyst to the triglyceride composition of the present invention;

FIG. 8 is a depiction of a water erosion resistance test apparatus as described in more detail herein; and

FIG. 9 is a depiction of a health parameter guide and related description as described in more detail herein.

### DESCRIPTION OF THE PREFERRED EMBODIMENTS

The present invention is directed to improved methods and systems for, among other things, stabilizing and hardening unpaved areas. The configuration and use of the presently preferred embodiments are discussed in detail below. It should be appreciated, however, that the present invention provides many applicable inventive concepts that can be embodied in a wide variety of contexts other than stabilizing and hardening unpaved areas. Accordingly, the specific embodiments discussed are merely illustrative of specific ways to make and use the invention, and do not limit the scope of the invention.

The triglycerides used in the composition of the present invention are typically commercially-available oils and greases. In general, the oils that are best suited for use as a component of the composition of the present invention are naturally-derived oils that contain mono- and poly-unsaturated fatty acid triglycerides, although some saturated fatty acid triglycerides may also be naturally present. Broadly speaking, all commonly used vegetable oils are suitable, for example corn oil, peanut oil, grapeseed oil, canola oil, sunflower oil, safflower oil, soybean oil, cottonseed oil, and many others. However, as a practical matter, the most commonly used, inexpensive, and readily available material is used cooking oil, which is commonly referred to as “yellow grease,” a commodity material that is widely available from restaurants and similar sources. Embodiments of the invention require that the oils contain sufficient amounts of unsaturated triglycerides to provide the polymerization and crosslinking necessary for the hardening of the unpaved surface.

The triglyceride composition of the present invention is comprised of a homogenized mixture of the triglycerides described above, a surfactant agent, and water. The surfactant serves to stabilize the emulsion composition, keeping it from separating into two layers, while also facilitating the penetration and wetting of the unpaved surface. The surfactant can be one or more of many known in the art. For example, various anionic, cationic, and nonionic surfactants are suitable but, as a practical matter, low-cost surfactants such as sodium lauryl sulfate and sodium laureth sulfate are most commonly used.

Some embodiments of the invention require that the composition be sufficiently homogenized to affect a uniform application of the composition to the surface. The ratio of water and triglycerides may vary considerably. For light applications of the composition, the volume ratio of water to triglycerides may be as high as 50:1. For heavy applications of the compositions, the volume ratio of water to triglycerides may be as low as 2:1. The amount of surfactant added to the composition is typically very small. For example, in one embodiment only approximately 16 ounces of surfactant are added to 1,000 gallons of the triglyceride composition.

Once the triglyceride composition has been suitably prepared, it is then uniformly applied to the unpaved surface. The triglyceride composition can be applied using any device or process for applying liquid, from man-portable units, such as backpacks with spray guns, to trailered sprayers that are connected to a tractor, to self-propelled units similar to tractors, with boom mounts of over 60 feet in length. In one embodiment, the composition is applied using a vehicle equipped with a storage tank containing the triglyceride composition. The tank is fluidly-connected to the spreader bar consisting of header pipe equipped with multiple liquid outlets or nozzles designed to provide a uniform surface application. The vehicle is then driven at a speed calculated to achieve the desired loading of the triglyceride composition. The amount of the triglyceride composition applied may vary widely depending on the nature of the unpaved surface and the desired degree of hardness of the finished surface. For example, in some instances the amount of composition applied may range from approximately 0.2 to 1.5 gallons per square foot of unpaved surface.

The triglyceride composition may be prepared remotely and transported to the site for application or, alternatively, prepared on-site using a truck equipped with processing equipment. In the later instance, the composition may be prepared immediately before it is applied to the unpaved area.

In one embodiment, a predetermined amount of one or more triglycerides is loaded into a tank affixed to a vehicle. Water is added to a separate tank along with a desired amount of surfactant. A relatively high-shear pump, such as a centrifugal pump or homogenizer, is used to ensure adequate mixing of the composition immediately prior to, or in close temporal proximity to, the time of application to the unpaved surface. The composition is mixed sufficiently to ensure that it is stable, but not mixed to a point wherein the composition is so viscous that it may not be easily applied using the application techniques described herein. In addition, the system may be configured with adjustable valves that can be set to allow for the proper ratio of the water/surfactant mixture and triglycerides into the pump for spraying at the desired rate.

When applying the triglyceride composition to the unpaved surface, the composition may penetrate into the unpaved surface to a depth of approximately ⅛ inch to 3 inches, depending on the composition of the surface and the hardness desired. In addition to maintaining the homogeneity of the composition as described above, the surfactants aid in allowing the composition to efficiently penetrate between the particles that form the unpaved surface to initially form a dense, wet, composite material composed of the original unpaved surface particles combined with the liquid triglyceride composition. The composition effectively saturates and fills the voids between the particles forming the unpaved surface.

After the triglyceride composition has been applied to the unpaved surface, the saturated surface is allowed to cure. During this process, the carbon-carbon double bonds within the unsaturated fatty acids are susceptible to oxidative attack from the oxygen that absorbs from the air into the composition, leading to polymerization of the triglycerides.

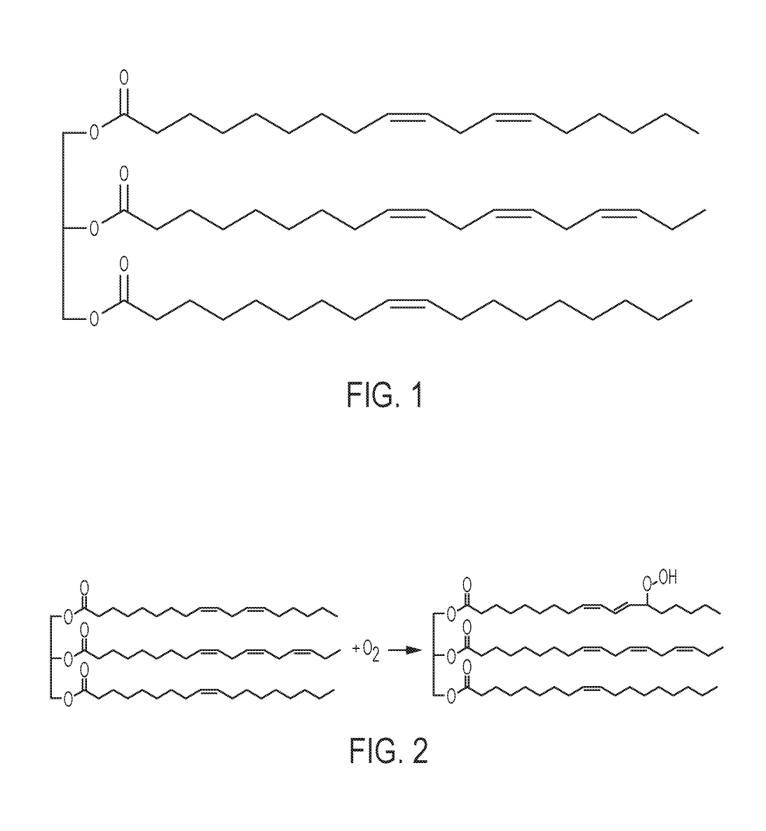

Technically, the fats and oils used in the triglyceride composition are triacylglycerols, or triesters of glycerol with three long-chain carboxylic acids. Roughly forty different fatty acids occur naturally. An example of a typical triglyceride molecule that may be found in used cooking oil is shown in FIG. 1. In the particular example of FIG. 1, the three long-chain carboxylic acids from top to bottom include linoleic acid, alpha-linolenic acid, and oleic acid. There are many hundreds of combinations of carboxylic acids that may be combined with glycerine to form individual triglyceride molecules which make up vegetable oil.

During the curing process, oxygen from the air comes into contact with the triglyceride mixture, thereby causing cross-linking of the long-chain carboxylic acids. Because of the wide variety of triglycerides that may be used in the triglyceride composition of the present invention, the cross-linking process may vary widely. The chemistry of the oxidation and polymerization is complex, involving formation of various intermediate peroxide species and free radicals, ultimately resulting in the formation of carbon-oxygen-carbon and carbon-carbon bonds that link together the triglyceride molecules into a high molecular weight solid polymeric material.

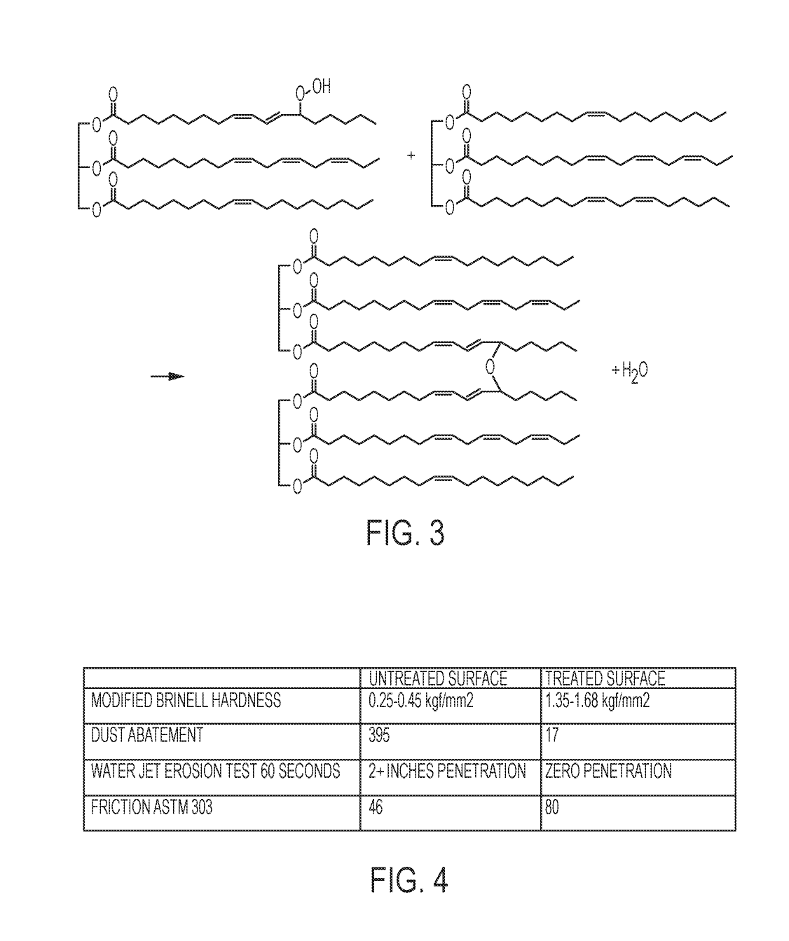

In one example, the process proceeds by reacting oxygen from the air with the triglyceride molecule to form a hydroperoxide as shown in FIG. 2. That hydroperoxide then reacts with another triglyceride molecule to form a crosslink between the two triglyceride molecules as shown in FIG. 3. The reaction between triglycerides continues as multiple crosslinks form between triglycerides, eventually forming the crosslinked polymeric structure which gives the cured triglyceride composition of the present invention its hardness and strength. As the crosslinking continues, a composite material is created consisting of particles of road surface, such as limestone or other mineral particles, that are completely encased in the solid polymer matrix. The hardness and mechanical properties of the resulting composite material are superior to the properties of either the road particles alone or the polymerized triglyceride composition by itself.

The curing process may be accelerated by application of heat, visible light, and ultraviolet light, as well as the addition of chemical accelerants. For example, the curing process may be accelerated by adding small catalytic amounts of cobalt, iron, or manganese or certain oil-soluble metal salts of organic acids. Moreover, some road-base materials such as limestone may already have catalytic amounts of these metals which may naturally accelerate the curing process.

### Test 1—Surface Quality Comparison to an Untreated Surface

To demonstrate the efficacy of the triglyceride composition of the present invention, several tests were performed to compare the properties of an unpaved surface before and after the application of the composition to unpaved surfaces. In the first test, an unpaved surface consisted of approximately 10,000 square feet of compacted limestone road base. The triglyceride composition for this test consisted of 300 gallons of used cooking oil, or yellow grease, 1,500 gallons of water, 8 ounces of sodium lauryl sulfate, 8 ounces of sodium laureth sulfate, and 20 ounces of manganese sulfate. The composition was blended using a centrifugal pump with 6-inch impeller, operating at 2,800 rpm. The composition was applied to the unpaved surface at 15 gallons/minute using a bar sprayer with 10 nozzles spaced 12 inches apart, resulting in a total loading of 25.6 ounces of the triglyceride composition per square foot.

The surface was tested before and after treatment using a number of different tests. The surface was underwent a modified Brinell hardness test. The Brinell hardness number is defined as the ratio of test load to the surface area of indentation. The test uses a 22.22 millimeter (0.875 in) diameter steel ball as an indenter with a 390.72 Kgf (2001 bf) force. The indentation is measured and hardness calculated as:

$$BHN = \frac{2 P}{π D ( D - \sqrt{{D}^{2} - {d}^{2}} )}$$

where:

BHN=Brinell hardness number (kgf/mm2)

P=applied load in kilogram-force (kgf)

D=diameter of indenter (mm)

d=diameter of indentation (mm)

Compared to the other hardness test methods, the indenter used in the Brinell test makes the deepest and widest indentation, so that the test averages the hardness over a wider amount of materials which will account for multiple grain structures and any irregularities in the uniformity of the material.

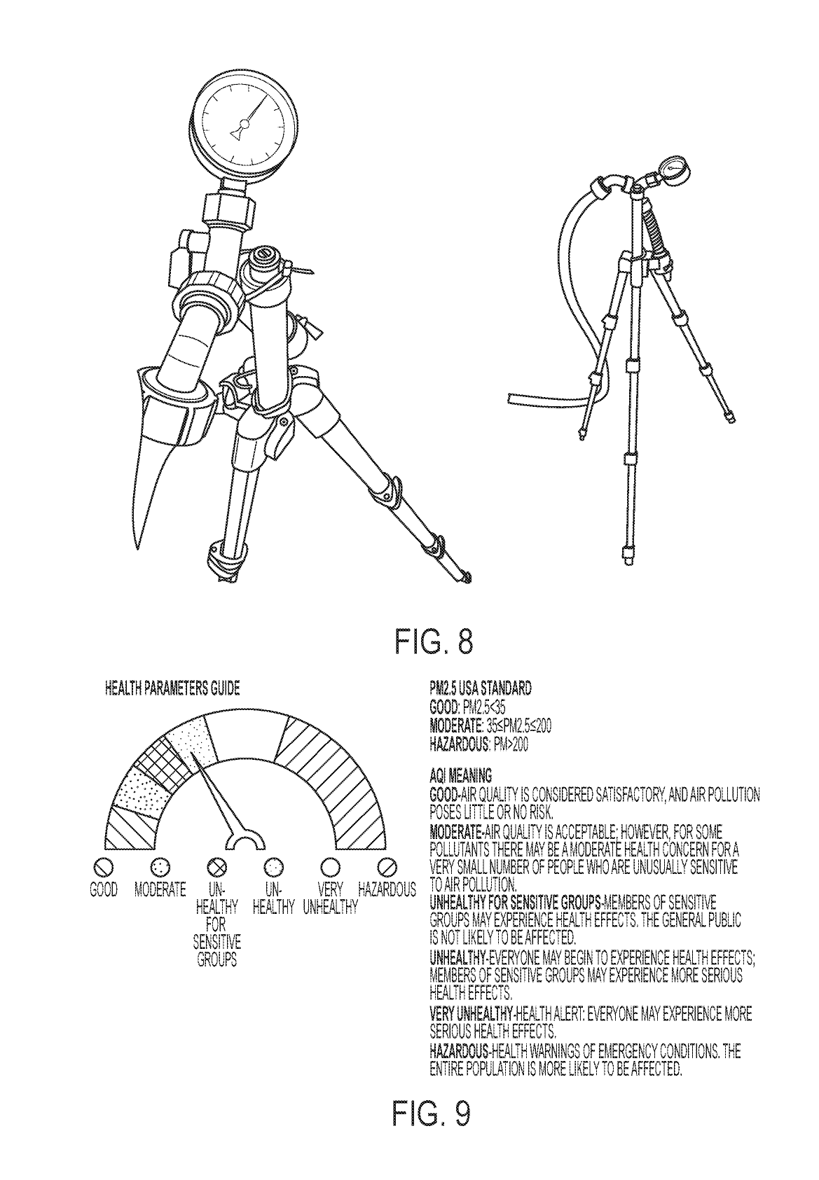

The surface was also tested using a water erosion test in which the surface is subjected to 60 seconds of perpendicular jet spray at 50+ psi through a 0.125″ orifice using custom designed equipment. A graphic depiction of the apparatus used in the water jet erosion test is shown in FIG. 8. The surface penetration depth after the 60 second test is recorded.

The surface was also tested using a method to quantify road dust particulate matter (PM) emissions (PM₁₀ and/or PM₂₅) from vehicular travel on paved and unpaved roads. This test method is designed to quantify road dust particulate matter emissions from vehicles traveling on paved and unpaved roads. The method relies on the measurement of the increase in PM concentrations over ambient background levels at one or more locations that are directly influenced by road dust that is emitted from the interaction of vehicle tires with the road surface. This method can be applied to any unpaved dirt or gravel road that is 100 meters or greater in length. The health parameter guide and corresponding meaning is included in FIG. 9.

Finally, the surface was tested using ASTM standard test method E303 measuring the coefficient of surface friction. This test method provides a measure of a frictional property, microtexture of a surface, either in the field or in the laboratory. The British pendulum tester is a dynamic pendulum impact-type tester used to measure the energy loss when a rubber slider edge is propelled over a test surface. Comparative testing of concrete and asphalt surfaces shows readings of 85 and 95, similar to what was attained using the triglyceride mixture of the present invention.

Referring now back to FIG. 4 and the results of the first test. The treated surface showed marked improvements over the untreated surface. The hardness was increased by a factor of 4 to 5, the dust abatement level was reduced from a “hazardous” level to a “good” level the paved surface was, remarkably, not penetrated throughout the water jet erosion test, and the treated surface showed significant improvement in the friction test.

Additional field tests measured load-deflection data using the Texas Department of Transportation MODULUS 6.0 computer program based on the linear elastic system. This field test generated a treated layer load test modulus of 163 ksi, compared to untreated base standard of 60-75 ksi, showing substantial load bearing improvement with road base that had been treated with the triglyceride composition of the present invention.

### Test 2—Effect of Triglyceride Mix Ratio on Surface Quality

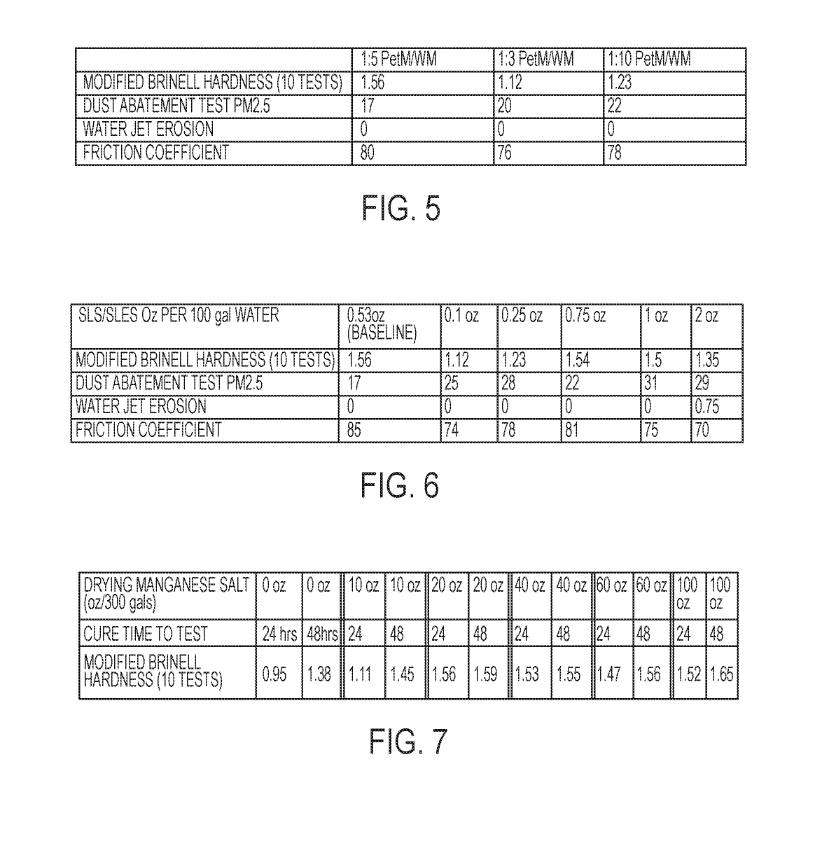

This second test measured the effect on surface quality of changing the ratio of triglycerides to water and surfactant. The triglycerides were mixed with a 0.53 ounces sodium lauryl sulfate and 0.53 ounces sodium laureth sulfate per 100 gallons of water to achieve triglyceride/water and sulfate ratios of 1:5, 1:3 and 1:10. The mixture was applied at a loading of 0.15 gal/ft² (i.e. 24 ounces triglyceride composition/ft²) over a10,000 square foot area of graded and rolled fines and road base. The resulting measurements of surface hardness, friction, resistance to water erosion and dust abatement are shown in FIG. 5. The optimal hardness was obtained at a triglyceride composition having a triglyceride to water and surfactant ratio of 1:5, and hardness declined significantly outside the range of 1:3 to 1:10. Dust control results, water jet erosion and friction coefficient all showed little change across the entire range of compositions from 1:3 to 1:10.

### Test 3—Effect of Sodium Lauryl Sulfate and Sodium Laureth Sulfate Volumes on Surface Quality

Varying ratios of surfactant were tested in the third test to determine a preferred range of surfactant and the results are shown in FIG. 6. Equal amounts of sodium lauryll sulfate and sodium laureth sulfate were added to the composition, with a preferred hardness observed in a range of 0.25-1 ounces per 100 gallons of water. There was little effect observed on dust abatement or water jet erosion for levels of surfactant below 2 ounces per 100 gallons, and friction coefficient declined for mix levels above 0.75 ounces per 100 gallons.

### Test 4—Effect of Catalyst on Hardening Process Rate

Finally, the effect of a catalyst on the drying process was tested in a fourth test. More specifically, the effect of manganese sulfate in speeding the auto-oxidation process to “harden” the triglyceride composition after application was tested. Manganese sulfate is believed to act as a catalyst to make the triglyceride composition harden more quickly. The results of this test are shown in FIG. 7.

The test results show significant shortening of drying times to achieve final hardness with the use of at least 20 ounces manganese sulfate per 300 gallons of the triglyceride composition. A preferred hardness is achieved in 24 hours using a minimum of 20 ounces manganese salt per 300 gallons of the triglyceride composition.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of methods for the preparation of unpaved areas known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

We claim:

1. A method for hardening unpaved surfaces, comprising:
mixing one or more triglycerides with water and one or more surfactants to form an emulsion;
preparing the unpaved surface for application of the emulsion;
applying the emulsion to the unpaved surface; and
allowing the emulsion to cure, thereby forming a hardened surface.

2. The method of claim 1, wherein the unpaved surface is a road base.

3. The method of claim 1, wherein the unpaved surface includes limestone.

4. The method of claim 1, wherein preparing the unpaved surface includes removal of vegetation.

5. The method of claim 1, wherein preparing the unpaved surface includes compaction with a heavy roller or a vibratory compactor.

6. The method of claim 1, wherein the one or more triglycerides consist of triacylglycerol with three long chain carboxylic acids selected from the group consisting of linoleic acid, alpha-linolenic acid and oleic acid.

7. The method of claim 1, wherein the one or more triglycerides are presented in the form of vegetable oil.

8. The method of claim 1, wherein the one or more triglycerides are presented in the form of used cooking oil.

9. The method of claim 1, wherein the one or more surfactants are one or more of sodium laurel sulfate and sodium laureth sulfate.

10. The method of claim 1, wherein the ratio of the one or more triglycerides to water is between approximately 2:1 and 50:1.

11. The method of claim 1, wherein a homogenizer is used for mixing the one or more triglycerides with water and the one or more surfactants.

12. The method of claim 1, wherein the emulsion is also applied to the unpaved surface while preparing the unpaved surface for the application of the emulsion.

13. The method of claim 1, wherein the hardness of the hardened surface is at least 1.35 kgf/mm₂.

14. The method of claim 1, wherein the emulsion is applied at a rate of between 0.2 and 1.5 gallons per square foot.

15. The method of claim 1, wherein the PM2.5 road dust particulate matter emissions measure is greater than 35 prior to application of the emulsion and less than 35 after application of the emulsion.

16. The method of claim 1, wherein the PM2.5 road dust particulate matter emissions measure is greater than 300 prior to application of the emulsion and less than 20 after application of the emulsion.

17. The method of claim 1, wherein the emulsion further includes a catalyst.

18. The method of claim 1, wherein the emulsion further includes a catalyst selected from the group consisting of cobalt, iron and manganese.

19. A roadway surface produced according to the method presented in claim 1.
